(19) United States
(12) Patent Application Publication
(10) Pub. No.: US 2005/0286834 A1
(43) Pub. Date: Dec. 29, 2005

(54) Waveguide assembly and connector

(75) Inventors: Nigel B. Aldridge, Wotton-under-Edge (GB); Ian J. Read, Bristol (GB); Peter D. Foote, Trellech (GB)

Correspondence Address: NIXON & VANDERHYE, PC, 901 NORTH GLEBE ROAD, 11TH FLOOR, ARLINGTON, VA, 22203, US

(73) Assignee: BAE SYSTEMS plc, London (GB)

(21) Appl. No.: 10/523,718

(22) PCT Filed: Dec. 21, 2004
(86) PCT No.: PCT/GB04/05373

§ 371 Date: Feb. 7, 2005

(30) Foreign Application Priority Data
Dec. 22, 2003 (GB) 0329640.7
Dec. 22, 2003 (EP) 03258125.8

(51) Int. Cl. G02B 6/38

(52) U.S. Cl. 385/55; 385/56; 385/69; 385/58; 385/70

(57) ABSTRACT

One aspect of the invention provides a waveguide assembly (250) for providing an interface to a surface module (260). The waveguide assembly comprises an embedded waveguide (204) embedded in a substrate material (224) and a waveguide connector (200) coupled to the embedded waveguide (204). The waveguide connector (200) has a neck portion (202) disposed transverse to the embedded waveguide (204) and a waveguide channel (214) passing though the neck portion (202) forming a channel between the embedded waveguide (204) and the surface (226) of the substrate material (224).

### FIELD

The present invention relates to waveguide assemblies and connectors. In particular, but not exclusively, it relates to waveguide assemblies and connectors for providing an interface from an embedded waveguide to a co-operating module located, for example, at the surface of a panel forming part of an aircraft structure.

### BACKGROUND

The provision of embedded waveguide structures to provide embedded sensing and/or embedded communications channels provides various known benefits. Where such waveguide structures are provided integrally within, for example, an aircraft, relatively light materials, such as, for example, optical fibres (fibre optics) may be provided, which are not only lighter than traditional metal wiring, but also relatively noise-immune and inexpensive.

While it is desirable to embed waveguide structures within panels that form a larger structure, such as, for example, a building or aircraft it has proved to be reasonably difficult and time consuming to provide reliable connections to such embedded waveguide structures, particularly during the process of manufacturing the larger structure.

Conventionally, to produce a panel, such as a composite panel for an aircraft incorporating an embedded waveguide, a waveguide (such as, for example, a fibre optic) is embedded in the composite panel and emerges from an edge of the panel from where it is terminated into a connector. However, not only are such so-called “edge connectors” labour intensive to produce, but they also place substantial limitations upon any subsequent modification to the panels. This in turn means that it has been necessary to provide a range of different panels in different shapes and sizes to assemble into the larger structure. This not only increased the tooling costs and complexity involved in producing a complex larger structure, but also gave rise to a requirement for intensive use of skilled labour capable of making the edge connectors.

Further, for certain applications, it may not be possible to use panels that include edge connectors which include so-called flying leads. Edge connectors can also make panel production more difficult, particularly where such panels are manufactured using a vacuum technique in which the panel is enveloped by a vacuum bag, since such vacuum bags tend to snap edge emerging fibres when a vacuum is being generated.

In order to address the problems associated with panels using edge connectors, and in particular in order to provide a panel that could be shaped after manufacture to allow, for example, for the removal of peripheral defects, the Applicants have previously devised various ways of interfacing to embedded waveguides. Various methods are discussed further in the present Applicant's patent applications EP-A1-1,150,145 and EP-A1-1,150,150, the contents of which are hereby incorporated herein by reference in their entirety.

The aforementioned patent applications describe various ways of interfacing optical fibres, incorporated into components made using composite materials, to surface-mountable interface modules. The optical fibres are accessed from the surface of the components post-manufacture in order to leave the surface of the components free of incisions, cavities and the like during the assembly of various components into a larger structure, such as, for example, an aircraft body.

While embedding of optical fibres and various interfacing components within a substrate, such as a composite material, can facilitate assembly of such a larger structure, since waveguide connections can be made post-assembly, this approach is not without certain drawbacks. Processing of the substrate structure to reveal embedded components with which to interface can be quite difficult and time-consuming. This is partly because the components must first be located and then subsequently exposed. Ease of exposure of components may also be hindered as the substrate structure will already be part of the larger structure which may in turn make accessibility an issue when attempting to “dig out” or expose the interface components. Furthermore, the task of exposing the embedded components calls not only for a skilled technician, but also requires the use of specialist equipment.

Another consideration in relation to conventional embedded connector components is that they may need to be non-standard, and thus may require additional manufacturing facilities to produce them. This can increase the relative cost and complexity when compared to standard type waveguide connectors. Moreover, use of such embedded connector components may also result in sub-optimal alignment, finishing, polishing, etc., thereby leading to relatively high insertion and/or coupling losses.

Additionally it is generally undesirable, post-assembly into a larger structure, to process substrate structures either near to the edges or the centre of the substrate, since this increases the chance of weakening the substrate structures and also may mean that they become damaged, possibly resulting in a need for their subsequent removal and replacement. Moreover, waveguide interfaces produced by exposing embedded components cannot be tested until they have been formed post-exposure, thereby introducing a risk that a defective panel be included in the larger structure. This could in turn require subsequent remedial attention, such as replacement of a section of structure, such as, for example, a full aircraft panel, despite the expenditure of the time and effort needed to expose the previously embedded components of the defective panel.

Various techniques relating to the use of fibre optic components and/or embedding of fibre optic components into substrate structures may also be found in the following documents, the teachings of all of which are hereby incorporated herein by reference in their entirety: “Termination and connection methods for optical fibres embedded in aerospace composite components,” A. K. Green and E. Shafir, Smart Materials and Structures, Volume 8(2), pp. 269-273 (1999); “Optical fiber sensors for spacecraft applications,” E. J. Friebele et al, Smart Materials and Structures, Volume 8(6), pp. 813-838 (1999); “Development of fibre optic ingress/egress methods for smart composite structures,” H. K. Kang et al, Smart Materials and Structures, Volume 9(2), pp. 149-156 (2000); “Infrastructure development for incorporating fibre-optic sensors in composite materials,” A. K. Green et al, Smart Materials and Structures, Volume 9(3), pp. 316-321 (2000); and “Manufacturing technique for embedding detachable fiber-optic connections in aircraft composite components,” A. Sjögren, Smart Materials and Structures, Volume 9(6), pp. 855-858 (2000).

The aforementioned considerations and documents have been borne in mind when devising the various aspects and embodiments of the invention, as herein described.

### SUMMARY

According to a first aspect of the invention, there is provided a waveguide assembly for providing an interface to a surface module. The waveguide assembly comprises a waveguide embedded in a substrate material and a waveguide connector coupled to the embedded waveguide. The waveguide connector has a neck portion disposed transverse to the embedded waveguide and a waveguide channel passing though the neck portion forming a channel between the embedded waveguide and the surface of the substrate material. The neck portion may protrude through the surface of the substrate material. The neck portion may itself comprise a waveguide for guiding radiation and/or may provide a channel in which a waveguide and/or elements connected to a waveguide may be disposed.

The substrate of the waveguide assembly may be used to provide a panel having a connector that is accessible at a surface of the panel. Such panels find use in many applications, such as, for example, for aircraft or motor vehicles. By providing a connector that is accessible at a surface of the panel, various embodiments of the invention provide panels which can be machined post-manufacture, without damaging the panel or waveguide assembly, in order for them to be incorporated into, for example, an aircraft structure or a racing car body. Accordingly, various embodiments of the invention enable the manufacture of larger structures incorporating a waveguide assembly, such as aircraft or other vehicles, to be more efficiently produced.

Furthermore, provision of a waveguide assembly that is accessible at a surface of a substrate allows for rapid and easy connection of surface modules which may be interchanged with various other surface modules, surface located patch cords etc. For example, a surface module connected to a temperature sensing system may be readily interchanged with a surface module connected to a fibre optic continuity tester so that the integrity of an embedded waveguide used to sense the temperature of a substrate can be verified during a maintenance check.

According to a second aspect of the invention, there is provided a waveguide connector for interfacing a waveguide embedded in a substrate material to a surface module. The waveguide connector comprises a neck portion for disposing transverse to an embedded waveguide and a waveguide channel passing though the neck portion for forming a channel between the embedded waveguide and a surface of a substrate material. The waveguide connector may be provided as a component for use in producing a waveguide assembly according to the first aspect of the invention.

A waveguide connector may comprise a base portion formed transverse to the neck portion. The base portion is suitable for stabilising the waveguide connector during a manufacturing process and/or when embedded in the substrate material. In various embodiments base portions may be provided to reduce the susceptibility of waveguide connectors to movement during incorporation of a waveguide connector into a waveguide assembly. Such stability may be provided by plate-like base portions that extend beyond the neck portion. The base portion may also help affix the waveguide connector when embedded in the substrate material. Waveguide connectors may be made of an inert metal alloy (or other material) that may have a low-reactivity with any surrounding substrate material in which it is to be embedded.

The waveguide channel may accommodate at least a portion of the waveguide. The embedded waveguide may comprise an optical fibre. Such an optical fibre may be selected for single and/or multimode operation at various wavelengths, such as, for example, one or more of: UV, visible, near-infrared and infrared wavelengths. In various embodiments an optical fibre comprises a fibre mini-bend, or tapered bend, to provide for low-loss beam directing/steering.

A section of the neck portion may protrude from the surface of the substrate material. Such a neck protrusion may help prevent ingress of various materials (such as, for example, epoxy resin or a component thereof) into a waveguide connector that might be used during manufacture when the waveguide connector is being embedded. A neck protrusion can be used in various embodiments to provide at least part of a connector for affixing to a surface module (such as, for example, a surface-mountable module comprising a further waveguide and/or interfacing components for coupling radiation into and/or out of the embedded waveguide). The neck portion may be provided at many different relative orientations with respect to the embedded waveguide or to a portion of the waveguide proximal to where it couples to a waveguide connector. For example, the neck portion may be perpendicularly disposed with respect to the embedded waveguide. The neck portion may include one or more formations for providing a connection to a surface component. Such formations may provide at least part of an engagement mechanism through which a surface module can positively engage with a waveguide connector.

According to a third aspect of the invention, there is provided a panel for an aircraft fuselage, component, body or hull, comprising a waveguide assembly according to any of the aspects and/or embodiments herein described. According to a fourth aspect of the invention, there is provided an aircraft comprising a panel according to the third aspect of the invention.

According to a fifth aspect of the invention, there is provided a method of manufacturing the aircraft according to the fourth aspect of the invention.

According to a sixth aspect of the invention, there is provided a surface module for interfacing to a waveguide assembly according to any of the aspects and/or embodiments herein described.

According to a seventh aspect of the invention, there is provided a method of manufacturing a waveguide assembly for providing an interface from an embedded waveguide to a surface module. The method comprises coupling a waveguide connector to a waveguide and embedding the waveguide connector and the waveguide in a substrate material. The waveguide connector has a neck portion disposed transverse to the waveguide and a waveguide channel passing though the neck portion for forming a channel between the waveguide and the surface of the substrate material.

The method may also comprise capping the waveguide connector prior to embedding the waveguide connector in the substrate material. By providing a cap, the waveguide connector may be sealed in order to inhibit the ingress of materials that might be used during the manufacturing process (such as, for example, epoxy resin or components thereof). Provision of a cap can also help when aligning various elements used in the manufacturing process.

The substrate material may itself consist of one or more composite material layers. Various layers may be provided, each having respectively aligned material fibres. The orientation of the material fibres in one layer can be made different with respect to the orientation of material fibres in one or more of the other layer(s). By varying the relative orientations of material fibres between layers, the strength-to-weight ratio of the composite material can be enhanced and/or any anisotropic mechanical properties of the composite material can be controlled.

### BRIEF DESCRIPTION OF THE DRAWINGS

Embodiments of the present invention will now be described, by way of example only, with reference to the accompanying drawings where like numerals refer to like parts and in which:

FIG. 1a shows a first embodiment of a waveguide connector according to an embodiment of the present invention;

FIG. 1b shows a second embodiment of a waveguide connector according to an embodiment of the present invention;

FIG. 2 shows a third embodiment of a waveguide connector during assembly into a waveguide assembly according to an embodiment of the present invention;

FIG. 3 shows the waveguide assembly of FIG. 2 during a subsequent processing stage;

FIG. 4 shows the waveguide assembly according to an embodiment of the present invention produced as in FIG. 3 and incorporated into a surface mounted connector;

FIG. 5 shows an aircraft system incorporating a waveguide assembly according to an embodiment of the present invention;

FIG. 6 shows a fourth embodiment of a waveguide connector according to an embodiment of the present invention;

FIG. 7 shows the waveguide connector of FIG. 6 during assembly into a waveguide assembly according to an embodiment of the present invention.

FIG. 8 shows the waveguide connector of FIG. 7 at a further stage of assembly into a waveguide assembly according to an embodiment of the present invention;

FIG. 9 shows a fifth embodiment of a waveguide connector during assembly into a waveguide assembly according to an embodiment of the present invention; and

FIG. 10 shows a sixth embodiment of a waveguide connector according to an embodiment of the present invention.

### DETAILED DESCRIPTION OF EMBODIMENTS OF THE INVENTION

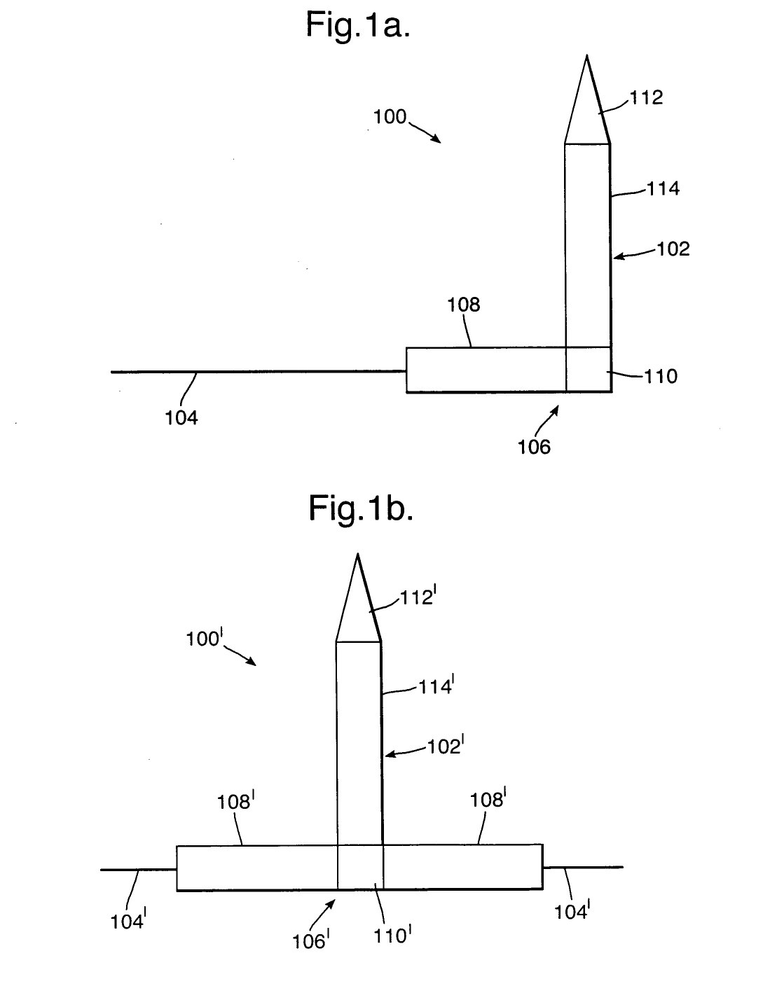

FIG. 1a shows a first embodiment of a waveguide connector 100. The waveguide connector 100 comprises a beam steering device 106 coupled to a transversely disposed waveguide channel 114 formed in a neck portion 102. The neck portion 102 may comprise, for example, one or more of: a glass rod, a graded index (GRIN) lens, an alignment sleeve, a tube, a ferrule into which a waveguide may fit etc. Examples of GRIN lenses that may be used are the 06 LGT, 06 LGS, 06 LGE and 06 LGD series of gradient index lenses supplied by Melles Griot Inc. of Carlsbad, Calif., U.S.A.

The beam steering device 106 comprises a GRIN lens 108 disposed adjacent to a corner cube 110. The GRIN lens 108 can be coupled to a fibre optic waveguide 104, and serves to collimate radiation emitted from the fibre optic waveguide 104 and/or to couple light from the GRIN lens 108 into the fibre optic waveguide 104. The beam steering device 106, neck portion 102 and fibre optic waveguide 104 may all be connected using standard techniques, such as, for example, bonding using optically transparent cement. For example, Epo-Tek 353ND optical glue may be used. The waveguide connector 100 can additionally be encased in an external housing (not shown) for protection when in use. Examples of angled prisms that may be used to make such corner cubes are the 01 PRT, 01 PRA, 01 PRP and 01 PRS series of angled prisms supplied by Melles Griot Inc. of Carlsbad, Calif., U.S.A.

The principle of the reciprocity of light ensures that the waveguide connector 100 can be used to couple radiation (such as, for example, optical radiation, infrared radiation etc.) both from and into the fibre optic waveguide 104. In the discussions herein, it is understood that this principle of reciprocity applies to all embodiments and aspects of the invention.

The corner cube 110 serves to steer radiation emitted from the GRIN lens into the waveguide channel 114. The waveguide channel 114 is disposed upstanding, for example, perpendicularly, with respect to the GRIN lens 108. In the embodiment illustrated, the corner cube 110 is chosen to steer a large amount of the radiation passing though the fibre optic waveguide 104 into the waveguide channel 114 (i.e. corner cube reflectivity is chosen to be as near to 100% as possible or practical). As illustrated in FIG. 1b, the reflectivity of a beam splitter 110′ may be selected to provide a tap-off point along a waveguide, such as fibre optic waveguide 104′. One or more such tap-off points can be provided/inserted along the length of such a waveguide.

FIG. 1a shows the end neck portion 102 located distal from the corner cube 110 connected to a cap 112. The cap 112 is made, for example, from a metal (e.g. ARCAP), plastic, rubber etc. and may be bonded to the neck portion 102. Various caps may merely use a push-fit connection to attach them to a neck portion. The cap 112 protects the end of the neck portion 102, and where the waveguide channel 114 comprises a tube, for example, it helps inhibit the ingress of materials that may be used during embedding of the waveguide connector 100 into a waveguide assembly, such as, for example, those waveguide assemblies of the type described in greater detail below.

The cap 112 is shaped to allow it to pass through material forming the substrate during embedding of the waveguide connector 100 into a waveguide assembly. Such material can be formed by a plurality of layers. The cap 112 may be pointed in order that it can be used to force the material of such layers apart to ensure that the material surrounds the neck portion 102. Alternatively, material layers may be provided with suitable incisions to accommodate the neck portion 102 and/or other elements provided with the waveguide connector 100.

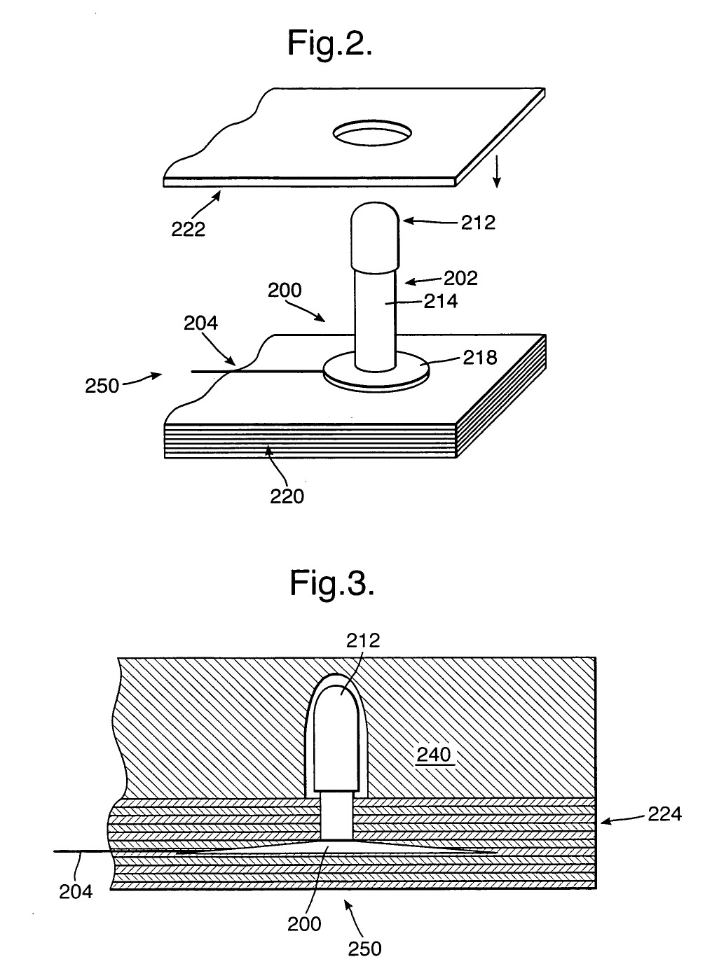

FIG. 2 shows a second embodiment of a waveguide connector 200 during assembly into a waveguide assembly 250. The waveguide connector 200 comprises a base 218 formed integrally with a neck portion 202. The waveguide connector 200 houses beam steering optical components (not shown) and is connected to a fibre optic waveguide 204. Radiation emitted from the fibre optic waveguide 204 is steered into the waveguide channel 214 by the beam steering optical components. The waveguide connector 200 is made of an inert material that does not adversely react with the material into which it is to be embedded. In various embodiments, a metal alloy like ARCAP or a plastics material such as PEEK may be used.

During assembly, the waveguide connector 200 and the fibre optic waveguide 204 are embedded into a substrate material. The substrate material is made of composite material. The neck portion 202 is capped by cap 212 prior to assembly, so as to protect the waveguide connector 200 during subsequent processing.

The composite material is made of two or more layers of material. In the embodiment illustrated in FIG. 2, the composite material 224 is made of a composite material support layer 220 and a plurality of composite material layers 222. The composite material support layer 220 can itself comprise one or more layers of material. Both the composite material support layer 220 and the composite material layers 222 may be made using layers of material comprising generally aligned fibres of glass, carbon, metal and/or Kevlar, impregnated or pre-impregnated with a resin material, and combinations of two or more such materials. The general orientation of the fibres of neighbouring layers can be varied to provide enhanced mechanical properties in the finished composite material 224. In other embodiments, materials having non-generally aligned strengthening fibres may be used.

During assembly, the waveguide connector 200 and the fibre optic waveguide 204 are initially supported on the composite material support layer 220. The shape of the base 218 serves to stabilise the waveguide connector 200. Composite material layers 222 are each provided with incisions to fit around the neck portion 202, the base 218 and/or the fibre optic waveguide 204. The incisions can be provided by laser-machining (e.g. by using an Excimer laser) which allows a fairly high degree of precision to be obtained. Provision of incisions allows for a snug fit of the composite material layers 222 about the neck portion 202, thereby reducing any aggregation (or bunching) of excess material that can occur, for example, where the neck portion of a waveguide connector is pushed directly through the composite material.

Composite material layers 222 are then added one at a time to build up the composite material 224. The general orientation of the fibres in each composite material layer 222 are varied from one layer to the next.

FIG. 3 shows the waveguide assembly 250 of FIG. 2 during a subsequent processing stage. The waveguide assembly 250 comprises the waveguide connector 200 coupled to the fibre optic waveguide 204 embedded in the composite material 224.

Consolidation tooling 240 is placed upon, or attached at, the surface of the composite material 224 so as to cover the cap 212. The consolidation tooling 240 acts to compress the layers of the composite material 224, particularly to ensure that the layers consolidate about the neck portion of the waveguide connector 200 to form a securely embedded waveguide connector 200. The consolidation tooling 240 also helps protect the waveguide connector 200 from resin ingress. Many forms of consolidation tooling 240 are possible, including, for example, a heavy weight or various tooling that positively engages the waveguide connector or other embedded element.

Once the waveguide assembly 250 has been constructed and the consolidation tooling 240 applied, as previously described, it is necessary to cure the composite material 224. Curing can be implemented by various methods such as chemical, pressure and/or heat induced variations in the physical/chemical composition of a resin either impregnated into fibres or found in layers pre-impregnated with a resin material.

As an example, where the composite material 224 is made using a plurality of composite material layers 222 that have been pre-impregnated with BMI resin material, the waveguide assembly 250 is subject to a temperature of 190° C. for 7 hours at a pressure of 100 psi, before being subject to a post-cure temperature of 245° C. Where standard epoxy resin is used, the waveguide assembly 250 is subject to a temperature of 175° C. for 5 hours at a pressure of 90 psi, before being subject to a post-cure temperature of 210° C. Where various other materials are used, a post-cure step may not be necessary.

Another technique to make a composite material is to use a resin transfer moulding (RTM) technique. The RTM technique uses fibre pre-form layers that are placed into a closed mould. Resin is injected into the mould at low pressure (<100 psi for thermosetting resin, subsequently cured at a temperature of 175° C. at 70 psi) to fill the voids in the fibre pre-form layers. The mould is then subject to a curing treatment to create the composite material.

When the composite material 224 has been cured, the consolidation tooling 240 and cap 212 are removed to reveal a section of the neck portion 202 of the waveguide connector 200 protruding above the surface 226 of the composite material 224.

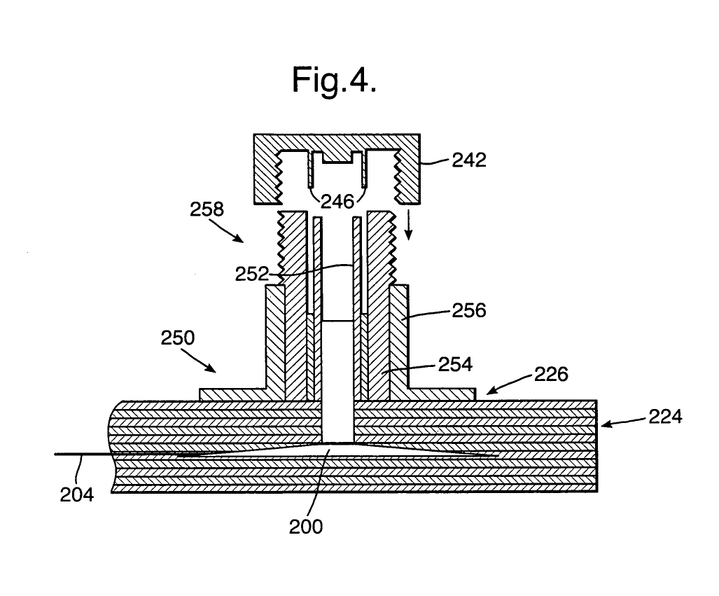

FIG. 4 shows the waveguide assembly 250 formed in accordance with FIGS. 2 and 3 incorporated into a surface mounted connector 258. The surface mounted connector 258 includes an external housing 256 surrounding an alignment sleeve 252 positioned about the section of the neck portion 202 that protrudes from the surface 226 of the composite material 224. A portion of the external housing 256 that is in contact with the surface 226 is coated with resin during assembly or provided with a film adhesive layer (not shown). Additionally, a support 254 is provided in the gap between the external surface of the alignment sleeve 252 and the inner bore of the external housing 256. The support 254 is provided to support the alignment sleeve 252. Such a support 254 may be made of various materials, such as, for example, a metal. The support 254 can be fixed to the surface 226 using, for example, a film adhesive layer.

A spacer cap 242 is applied to the screw threaded end of the external housing 256. The spacer cap 242 includes an annular protrusion 246 that serves to maintain a predetermined separation between the alignment sleeve 252 and the external housing 256. Once the spacer cap 242 is in place, the surface mounted connector 258 incorporating the waveguide assembly 250 can be cured if necessary to bond any adhesive(s), the surface 226, the external housing 256, the support 254, the alignment sleeve 252 and the protruding neck portion 202 of the waveguide connector 200.

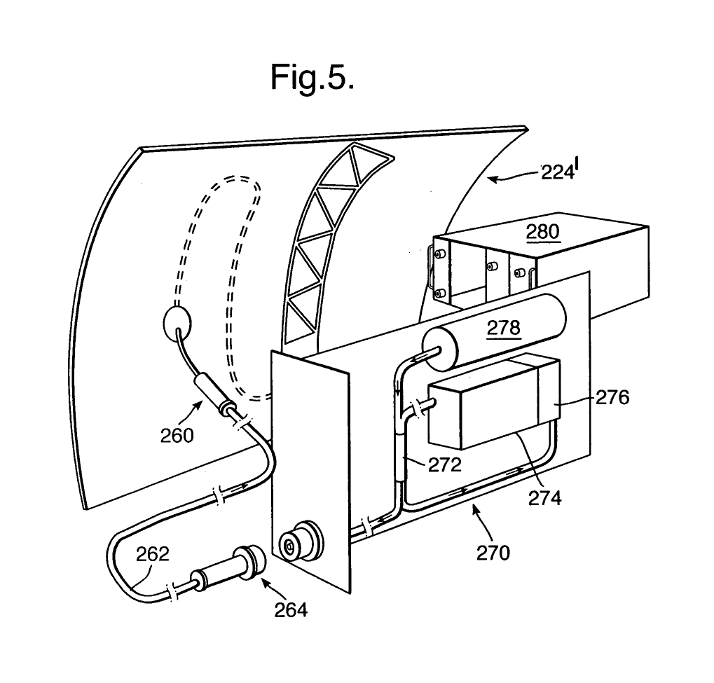

FIG. 5 shows an aircraft system incorporating a waveguide assembly. The waveguide assembly incorporates an embedded fibre sensor 204′ embedded in a panel of composite material 224′ connected to a non-perpendicular surface mounted connector 258′. The embedded fibre sensor 204′ is interrogated by inputting pump radiation through a surface module 260 and analysing any retro-propagating radiation.

Surface module 260 connects the surface mounted connector 258′ to an avionics card module 270, housed in an avionics rack 280, via fibre cable 262 and fibre connector 264. The avionics card module 270 comprises a fibre coupler 272 for splitting a pump radiation beam generated by a broadband light source 278. Part of the split pump radiation is directed to the fibre connector 264 for transmittal to the embedded fibre sensor 204′, and the other part is directed to photodiode 276. Retro-propagating radiation from the embedded fibre sensor 204′ is directed via the fibre coupler 272 to tuneable filter 274. Analysis of the photodiode 276 output enables information relating to the physical state of the embedded fibre sensor 204′, and thus the panel of composite material 224′, to be determined.

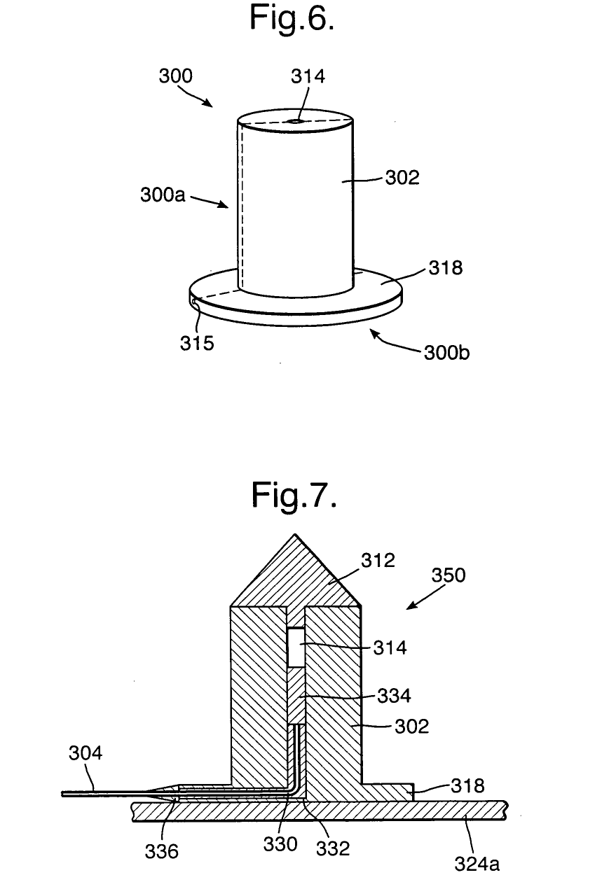

FIG. 6 shows a third embodiment of a waveguide connector 300. The waveguide connector 300 comprises a neck portion 302 and a base 318. The waveguide connector 300 is formed from two elements 300a and 300b, and which may comprise interlocking formations provided to inhibit resin ingress. Various other embodiments provide a central ferrule within a waveguide channel that inhibits the ingress of resin into that waveguide channel during curing of composite material.

The waveguide connector 300 includes a waveguide channel 314 in communication with a base channel 315. The waveguide connector 300 is made of an inert material, such as, for example, a metal alloy like ARCAP.

FIG. 7 shows the waveguide connector 300 during assembly into a waveguide assembly 350. The fibre optic waveguide 304 incorporates a 90° fibre bend 330. Such fibre optic waveguides incorporating fibre bends are commercially available, and provide a low-loss beam steering means. For example, such a fibre bend may be formed by controlled tapering of a fibre optic in a fusion splicer, such as a Bit Instruments BFS-60PPF. At one end of the fibre optic waveguide 304 a standard termination (cleaved and polished) to a ferrule 334 is made. The ferrule 334, the fibre bend 330 and a portion of the fibre optic waveguide 304 are then potted (i.e. affixed by embedding in a potting material, such as, for example, epoxy resin) between the two elements 300a and 300b along with a fibre boot 336 using potting material 332. The fibre boot 336 is provided to prevent damage occurring to the fibre optic waveguide 304 during any subsequent processing steps near to where the base channel 315 exits from the waveguide connector 300. Alternatively, a slot may be provided in the base 318 to house the fibre during potting. This accommodates any movement that occurs during the embedding process and also allows the fibre optic waveguide 304 to become surrounded by substrate material thereby eliminating the need to provide a fibre boot 318.

Once potting is complete, cap 312 can be applied to the waveguide connector 300 to protect the waveguide channel 314 from resin ingress, and the procedure for embedding the waveguide connector 300 into the waveguide assembly 350 can begin.

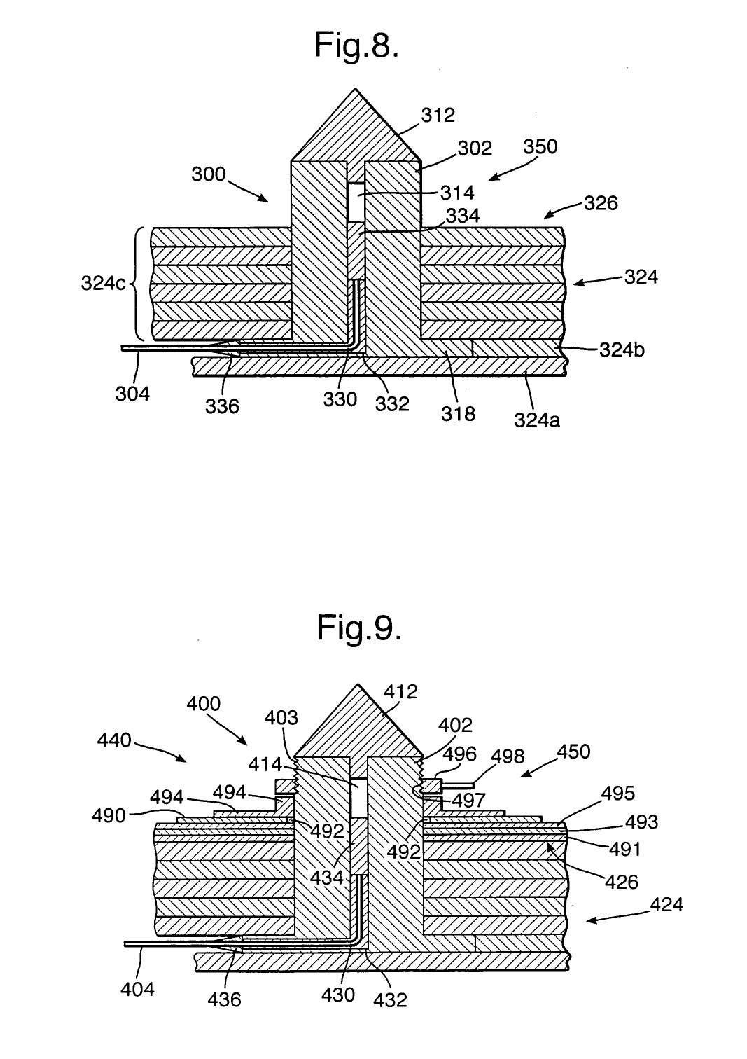

FIG. 8 shows the waveguide connector 300 at a further stage of assembly into the waveguide assembly 350. The fibre optic waveguide 304 protruding from the fibre boot 336 and the base of the waveguide connector 300 are set upon a composite material base layer 324a, which may itself comprise one or more layers of material. Keyed composite material layer 324b comprising excisions for accommodating the fibre optic waveguide 304 and the base 318 is then placed over the waveguide connector 300. A plurality of composite layers 324c comprising excisions for accommodating the neck portion 302 are then arranged about the waveguide connector 300. The layers of material 324a, 324b and 324c comprise respective generally aligned fibres impregnated with resin, and the relative orientation of these fibres is varied between adjacent layers. Consolidation tooling (not shown) may be placed about the neck portion 302 in order to compress the layers of material 324c so as to prevent bunching of those layers of material 324c about the neck portion 302.

FIG. 9 shows a waveguide connector 400 during assembly into a waveguide assembly 450. The waveguide connector 400 is similar to that shown in FIG. 8, except that the neck portion 402 is provided with a screw threaded portion 403. The screw threaded portion 403 facilitates the connection of consolidation tooling 440 to the waveguide connector 400.

The consolidation tooling 440 is provided to consolidate the layers that form the composite material 424 during the curing process. The consolidation tooling 440 comprises a connector seal 490, a consolidation base 494 and a threaded compression collar 496 disposed about the neck portion 402 of the waveguide connector 400. A vacuum bag 495 is provided to cover the surface 426 and to envelope the whole substrate comprising the composite layers. The vacuum bag 495 is supported by a breather cloth 493. The breather cloth 493 is separated from the surface by peel ply 491. Curing takes place under reduced pressure and the vacuum bag 495 serves to consolidate material forming the substrate. External pressure may also be applied during the curing process to aid in consolidation of the layers.

Breather cloth 493 is provided to enable the vacuum bag 495 to provide pressure to the composite material in the region of the neck portion 402. The breather cloth 493 also allows for a free flow of air, and so aids the removal of air from within the vacuum bag 495. Peel ply 491 allows the consolidation tooling 440 to be removed once curing has taken place without becoming bonded to the surface 426.

The connector seal 490 has a hardened ring portion 492. The hardened ring portion 492 is used to exert extra force to consolidate the composite material 424 proximal to the waveguide connector 400. The consolidation base 494 is placed over the connector seal 490. The consolidation base 494 is freely mounted about the neck portion 402 and has a flat surface for making contact with the connector seal 490. The thread 497 of the threaded compression collar 496 engages with the screw threaded portion 403 provided proximal the end of the neck portion 402. The threaded compression collar 496 is provided with a tightening bar 498 that aids in the turning thereof. Screwing the threaded compression collar 496 towards the surface 426 of the composite material 424 causes the consolidation base 494 to exert force on the connector seal 490 thereby aiding in consolidation of the composite material 424.

Once the threaded compression collar 496, and thus the consolidation tooling 440, is firmly in place the whole waveguide assembly 450 can be cured to set the composite material 424. For example, curing may be achieved by using one of the techniques previously described.

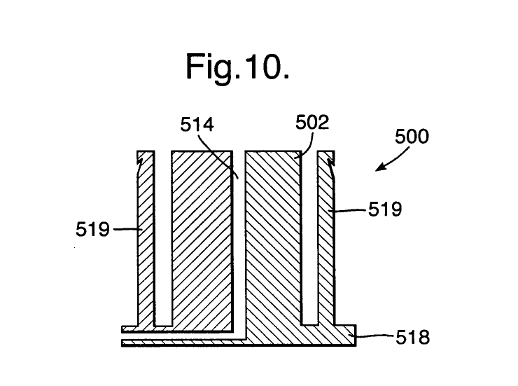

FIG. 10 shows a waveguide connector 500. The waveguide connector 500 is similar to that shown in FIG. 8, except that the base 518 is provided with connector elements 519 that can project above a surface of a composite material (not shown). a screw threaded portion 403. The connector elements 519 facilitate the connection of consolidation tooling (not shown) to the waveguide connector 500. The connector elements 519 may also be used as part of a connector when incorporated into a composite material, provided with excised layers configured to surround the neck portion 502 and the connector elements 519.

In various embodiments, the waveguide connector can be formed using a solid material. Such a waveguide connector may be formed from an inert material, such as, for example, a metal alloy such as ARCAP. Such a waveguide connector may comprise, a glass shaft or a graded index rod, for example, forming a neck portion. The waveguide channel of such embodiments is thus formed in the solid material itself. In various other embodiments, the waveguide connector can be formed using hollow elements, such as, for example, an alignment sleeve or ferrule.

The size and/or cross-sectional shape of the neck portion can be selected according to the connector type that is desired to be formed at the surface of the substrate material. In various embodiments, the diameter of the neck portion is made from about 2 mm to about 6 mm. Use of relatively small diameter neck portions for waveguide connectors provides for minimal structural modification to the material in which the waveguide connector may subsequently be embedded. This helps reduce any impact on the overall strength of substrate parts/panels which incorporate such waveguide connectors. According to the method of construction of the substrate parts/panels, use of relatively small diameter neck portions may also facilitate the manufacturing process (for example, by avoiding the need to provide pre-defined holes in various substrate material layers).

Waveguide connectors of the type described herein allow waveguides to be embedded at various controllable depths within a substrate material. Such waveguide connectors can also provide low loss connections from an embedded waveguide to a surface module. Many such waveguide connectors and waveguide assemblies comprising them will be apparent to those skilled in the art. Various embodiments of the invention provide that edge trimming of panels incorporating the waveguide assembly, which is often necessary when fitting such panels to, for example, an aircraft frame, does not affect the waveguide connector.

Viewed from another aspect, the invention provides a waveguide connector for connecting a waveguide embedded in a substrate material to a surface component located at a surface of the substrate material, said waveguide connector comprising a waveguide retaining member (WRM) disposed transverse to an embedded waveguide, wherein said waveguide retaining member is for forming a channel between said waveguide and the surface of a substrate material.

Those skilled in the art will be aware that various lenses, mirrors and/or, waveguides can be provided to steer radiation from a waveguide into one or more transverse direction. They will also be aware that waveguides may be single/multimode. Those skilled in the art will also realise that substrates and/or substrate layers may be provided without the need to provide recesses/incisions. For example, a cap may be used to perforate a substrate material without the need to first provide an aperture in that substrate material.

Those skilled in the art will also realise that embodiments of the invention can be incorporated into various standard connectors, such as, for example, HA, FC, FC/PC etc. connectors. Use of various embodiments of the invention in conjunction with various known connectors can have cost benefits and provides for improved compatibility with existing systems/devices/components that connect to existing embedded waveguide assemblies. Those skilled in the art will also realise that waveguide connectors according to various embodiments of the invention can be used to provide non-standard types of connectors, either by themselves or when used with further components, for coupling an embedded waveguide to various bespoke surface modules.

As is understood by those skilled in the art, the terms “embed,” “embedded” and “embedding” in relation to an object and a material relate to at least partially surrounding that object with the material. Those skilled in the art will also understand that waveguides need not be disposed linearly or coplanar with respect to a substrate material. For example, an embedded waveguide may be circularly wound along its length to provide a coiled optical fibre amplifier portion formed within a waveguide assembly. Moreover, those skilled in the art will understand that aligned material fibres of various composite material layers need not be perfectly parallel but may, for example, only be generally aligned in one or more direction within a material layer. Those of ordinary skill in the art will also be aware that in various embodiments substrate materials may be composite materials.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

The scope of the present disclosure includes any novel feature or combination of features disclosed therein either explicitly or implicitly or any generalisation thereof irrespective of whether or not it relates to the claimed invention or mitigates any or all of the problems addressed by the present invention. The applicant hereby gives notice that new claims may be formulated to such features during the prosecution of this application or of any such further application derived therefrom. In particular, with reference to the appended claims, features from dependent claims may be combined with those of the independent claims and features from respective independent claims may be combined in any appropriate manner and not merely in the specific combinations enumerated in the claims.

1. A waveguide assembly, comprising:
a waveguide embedded in a substrate material; and
a waveguide connector coupled to the embedded waveguide, wherein the waveguide connector has a neck portion disposed transverse to the embedded waveguide and a waveguide channel passing though the neck portion forming a channel between the embedded waveguide and the surface of the substrate material, thereby providing an interface to a surface module.

2. The waveguide assembly of claim 1, wherein the waveguide connector comprises a base portion formed transverse to said neck portion, wherein the base portion is suitable for stabilising the waveguide connector during a manufacturing process and/or when embedded in the substrate material.

3. The waveguide assembly of claim 1, wherein the waveguide connector is made of an inert metal alloy.

4. The waveguide assembly of claim 1, wherein a portion of the neck portion protrudes from the said surface of the substrate material.

5. The waveguide assembly of claim 1, wherein the neck portion is perpendicularly disposed with respect to the embedded waveguide.

6. The waveguide assembly of claim 1, wherein the neck portion comprises one or more formation for providing a connection to a surface component.

7. The waveguide assembly of claim 1, wherein the waveguide channel accommodates at least a portion of the waveguide.

8. The waveguide assembly of claim 1, wherein the embedded waveguide comprises an optical fibre.

9. The waveguide assembly of claim 8, wherein the optical fibre comprises a fibre mini-bend or tapered bend.

10. The waveguide assembly of claim 1, wherein the substrate material is a composite material.

11. A panel for a vehicle fuselage, component, body or hull, comprising the waveguide assembly according to claim 1.

12. A vehicle comprising a panel according to claim 11.

13. A method of manufacturing a vehicle, comprising incorporating a panel according to claim 11 into a vehicle fuselage, component, body or hull.

14. A surface module for interfacing to the waveguide assembly according to claim 1.

15. A waveguide connector for interfacing a waveguide embedded in a substrate material to a surface module, the waveguide connector comprising a neck portion for disposing transverse to an embedded waveguide and a waveguide channel passing though the neck portion for forming a channel between the embedded waveguide and a surface of a substrate material.

16. The waveguide connector of claim 15, wherein the waveguide connector comprises a base portion formed transverse to said neck portion.

17. The waveguide connector of claim 15, wherein the waveguide connector is made of an inert metal alloy.

18. The waveguide connector of claim 16, wherein the neck portion extends perpendicularly from the base portion.

19. The waveguide connector of claim 15, wherein the neck portion comprises one or more formation for providing a connection to a surface component.

20. The waveguide connector of claim 15, wherein the waveguide channel is for accommodating at least a portion of a waveguide.

21. A method of manufacturing a waveguide assembly, comprising:
coupling a waveguide connector to a waveguide; and
embedding the waveguide connector and the waveguide in a substrate material, wherein the waveguide connector has a neck portion disposed transverse to the waveguide and a waveguide channel passing though the neck portion for forming a channel between the waveguide and the surface of the substrate material, thereby providing an interface from an embedded waveguide to a surface module.

22. The method of claim 21, comprising capping the waveguide connector prior to embedding the waveguide connector in the substrate material.

23. The method of claim 21, wherein the step of embedding the waveguide connector and the waveguide in a substrate material comprises providing a plurality of composite material layers to form the substrate material, each composite material layer surrounding the neck portion of the waveguide connector.

24. The method of claim 23, wherein each composite material layer comprises respectively aligned material fibres.

25. The method of claim 24, further comprising selecting the material fibres from one or more of the following materials: carbon, glass, metal and Kevlar.

26-31. (canceled)
